(19) United States
(12) Patent Application Publication
(10) Pub. No.: US 2014/0069909 A1
(43) Pub. Date: Mar. 13, 2014

(54) ELECTRONIC HEATER AND METHOD FOR CONTROLLING THE SAME

(71) Applicant: Huawei Technologies Co., Ltd., Shenzhen (CN)

(72) Inventors: Zhanli Tang, Shanghai (CN); Yake Fang, Kista (SE)

(73) Assignee: Huawei Technologies Co., Ltd., Shenzhen (CN)

(21) Appl. No.: 14/081,211

(22) Filed: Nov. 15, 2013

Related U.S. Application Data
(63) Continuation of application No. PCT/CN2011/074166, filed on May 17, 2011.

(51) Int. Cl. G05D 23/19; H05B 1/02

(52) U.S. Cl. CPC G05D 23/1919; H05B 1/023
USPC 219/498; 219/504

(57) ABSTRACT

Embodiments of the present disclosure disclose an electronic heater and a method for controlling the same and relate to the field of power electronic technologies, so as to reduce a maintenance cost of a spare part of the electronic heater. The electronic heater includes: an auxiliary power supply unit, a control unit, a power adjusting unit, and a heating source. The auxiliary power supply unit is configured to supply power to the control unit; the control unit is configured to output a detection voltage signal according to an input voltage of the heating source, output a power control signal according to a preset reference power value, and transmit the detection voltage signal and the power control signal to the power adjusting unit; and the power adjusting unit is configured to obtain an output power adjustment signal according to the detection voltage signal and the power control signal.

### CROSS-REFERENCE TO RELATED APPLICATIONS

This application is a continuation of International Application No. PCT/CN2011/074166, filed on May 17, 2011, which is hereby incorporated by reference in its entirety.

### TECHNICAL FIELD

The present disclosure relates to the field of power electronic technologies, and in particular, to an electronic heater and a method for controlling the same.

### BACKGROUND

With the development of communication technologies, there are more and more outdoor communication base stations. Because an outdoor environment is harsh, to ensure normal working of a base station, an electronic heater needs to be disposed by an operator inside a cabinet such as a power cabinet or a battery cabinet that is ancillary to an outdoor communication base station. Generally, when the electronic heater in the cabinet works, a power supply system supplies power to a heating source to enable the heating source to generate heat; an auxiliary power supply transforms a high voltage provided by the power supply system into a low voltage and provides the low voltage for a fan; and the fan blows the heat generated by the heating source into the cabinet to maintain a normal working temperature in the cabinet. The heating source is an improved resistance conductor such as a heating rod, a heating film, or a heating block.

In a working process of implementing the electronic heater, the inventor finds that the prior art has at least the following problems: An existing electronic heater is not flexible enough, that is, a heating power of the electronic heater is uncontrollable, and output power of the electronic heater cannot be flexibly adjusted according to a change of an actual use environment, and consequently, an operator needs to change different electronic heaters to maintain the same working temperature inside the cabinet or needs to equip an electronic heater of different power for a cabinet of different capacity, which increases a maintenance cost of a spare part.

### SUMMARY

Embodiments of the present disclosure provide an electronic heater and a method for controlling the same, so as to reduce a maintenance cost of a spare part of the electronic heater.

The embodiments of the present disclosure adopt the technical solutions as follows:

An electronic heater is provided, including an auxiliary power supply unit, a control unit, a power adjusting unit, and a heating source, where the auxiliary power supply unit is configured to supply power to the control unit; the control unit is configured to output a detection voltage signal according to an input voltage of the heating source, output a power control signal according to a preset reference power value, and transmit the detection voltage signal and the power control signal to the power adjusting unit; and the power adjusting unit is configured to obtain an output power adjustment signal according to the detection voltage signal and the power control signal, and adjust an input current of the heating source according to the power adjustment signal.

A method for controlling an electronic heater is provided, where when the electronic heater includes an auxiliary power supply unit, a control unit, a power adjusting unit, and a heating source, the method including:

when an external power supply supplies power, after transforming a voltage of the external power supply, sending, by the auxiliary power supply unit, the voltage to the control unit to supply power to the control unit;

outputting, by the control unit, a detection voltage signal according to a voltage signal obtained by the heating source, outputting a power control signal according to a preset reference power value, and sending the detection voltage signal and the power control signal to the power adjusting unit; and

obtaining, by the power adjusting unit, an output power adjustment signal according to the detection voltage signal and the power control signal, and adjusting a current of the heating source by using the output power adjustment signal, so as to adjust output power of the heating source, where the external power supply provides a voltage for the heating source.

In the electronic heater and the method for controlling the same provided in the embodiments of the present disclosure, when a supply voltage of a power supply system changes, the electronic heater provided in the present disclosure can intelligently adjust a current of a heating source of the electronic heater to maintain output power of the heating source unchanged, and therefore, an operator can make a cabinet maintain the same working temperature without changing different electronic heaters; and in addition, when the supply voltage of the power supply system maintains unchanged but capacity of the cabinet changes, the electronic heater provided in the present disclosure can adjust the current of the heating source of the electronic heater to increase or decrease output power of the heating source to maintain a proper working temperature of a cabinet of different capacity, and therefore, the operator does not need to equip an electronic heater of different power for a cabinet of different capacity. Therefore, by using the technical solutions in the embodiments of the present disclosure, a maintenance cost of a spare part of the electronic heater is reduced.

### BRIEF DESCRIPTION OF DRAWINGS

To describe the technical solutions in the embodiments of the present disclosure more clearly, the following briefly introduces the accompanying drawing required for describing the embodiments. Apparently, the accompanying drawings in the following description show merely some embodiments of the present disclosure, and persons of ordinary skill in the art may still derive other drawings from these accompanying drawing without creative efforts.

FIG. 1 is a schematic diagram of an electronic heater according to a first embodiment of the present disclosure;

FIG. 2 is a schematic diagram of an electronic heater according to a second embodiment of the present disclosure;

FIG. 3 is a schematic diagram of an electronic heater according to a third embodiment of the present disclosure;

FIG. 4 is a schematic diagram of an electronic heater according to a fourth embodiment of the present disclosure;

FIG. 5 is a schematic diagram of an electronic heater according to a fifth embodiment of the present disclosure;

FIG. 6 is a schematic diagram of an electronic heater according to a sixth embodiment of the present disclosure; and

FIG. 7 is a flowchart of a method for controlling an electronic heater according to a seventh embodiment of the present disclosure.

### REFERENCE NUMERALS IN THE DRAWINGS

01—first electrode of an external power supply;
02—second electrode of the external power supply;
1—electronic heater;
11—auxiliary power supply unit, 111—first input end of the auxiliary power supply unit, 112—second input end of the auxiliary power supply unit, and 113—output end of the auxiliary power supply unit;
12—control unit, 120—output/input port of the control unit, 121—first output end of the control unit, 122—second output end of the control unit, 123—third output end of the control unit, 124—first input end of the control unit, 125—second input end of the control unit, 126—third input end of the control unit, and 127—fourth input end of the control unit;
13—power adjusting unit, 131—first input end of the power adjusting unit, 132—second input end of the power adjusting unit, and 133—output end of the power adjusting unit;
14—heating source, 141—first input end of the heating source, 142—second input end of the heating source, and 143—control end of the heating source;
20—fan;
21—temperature collecting unit
22—heat dissipating unit;
23—sampling resistor;
24—first MOSFET, 241—source electrode of the first MOSFET, 242—drain electrode of the first MOSFET, 243—gate electrode of the first MOSFET;
25—second MOSFET, 251—drain electrode of the second MOSFET, 252—source electrode of the second MOSFET, and 253—gate electrode of the second MOSFET;
31—diode;
32—MOSFET, 321—drain electrode of the MOSFET, 322—source electrode of the MOSFET, and 323—gate electrode of the MOSFET;
41—MOSFET, 411—drain electrode of the MOSFET, 412—source electrode of the MOSFET, and 413—gate electrode of the MOSFET;
42—rectifying unit, 421—first input end of the rectifying unit, 422—second input end of the rectifying unit, 423—first output end of the rectifying unit, and 424—second output end of the rectifying unit;
51—MOSFET, 511—drain electrode of the MOSFET, 512—source electrode of the MOSFET, and 513—gate electrode of the MOSFET;
52—rectifying unit, 521—first input end of the rectifying unit, 522—second input end of the rectifying unit, 523—first output end of the rectifying unit, and 524—second output end of the rectifying unit;
53—first voltage adjusting unit, 531—first input end of the first voltage adjusting unit, 532—second input end of the first voltage adjusting unit, 533—first output end of the first voltage adjusting unit, and 534—second output end of the first voltage adjusting unit; and
63—second voltage adjusting unit, 631—first input end of the second voltage adjusting unit, 632—second input end of the second voltage adjusting unit, 633—first output end of the second voltage adjusting unit, and 634—second output end of the second voltage adjusting unit.

### DESCRIPTION OF EMBODIMENTS

The following clearly describes the technical solutions in the embodiments of the present disclosure with reference to the accompanying drawings in the embodiments of the present disclosure. Apparently, the embodiments to be described are merely apart rather than all of the embodiments of the present disclosure. All other embodiments obtained by persons of ordinary skill in the art based on the embodiments of the present disclosure without creative efforts shall fall within the protection scope of the present disclosure.

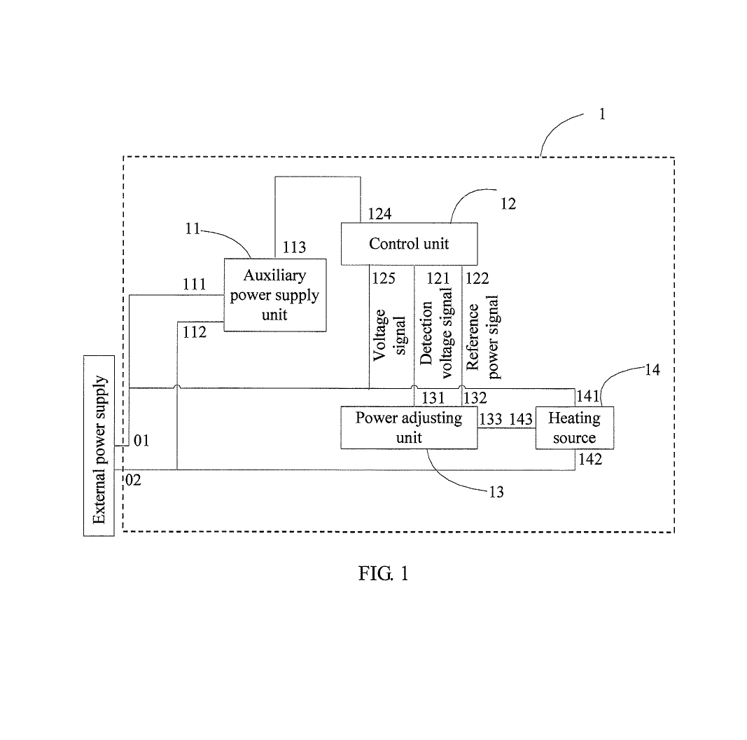

As shown in FIG. 1, a first embodiment of the present disclosure provides an electronic heater 1, which includes an auxiliary power supply unit 11, a control unit 12, a power adjusting unit 13, and a heating source 14. The auxiliary power supply unit 11 is configured to supply power to the control unit; the control unit 12 is configured to output a detection voltage signal according to an input voltage of the heating source 14, output a power control signal according to a preset reference power value, and transmit the detection voltage signal and the power control signal to the power adjusting unit 13; the power adjusting unit 13 is configured to obtain an output power adjustment signal according to the detection voltage signal and the power control signal, and adjust an input current of the heating source 14 according to the power adjustment signal; and the heating source 14 is configured to convert output electric power into heat energy.

Specifically, an input end of the auxiliary power supply unit 11 is connected to an external power supply and is configured to receive electric energy supply of the external power supply; an output end of the auxiliary power supply unit 11 is connected to a first input end of the control unit 12 and is configured to supply power to the control unit; a first output end and a second output end of the control unit 12 are connected to a first input end and a second input end of the power adjusting unit 13 respectively and are configured to transmit the detection voltage signal and the power control signal to the power adjusting unit; an output end of the power adjusting unit 13 is connected to a control end of the heating source 14 and is configured to adjust the input current of the heating source according to the power adjustment signal; a first input end and a second input end of the heating source 14 are connected to a first electrode and a second electrode of the external power supply respectively and are configured to receive the electric energy supply of the external power supply; and the first input end of the heating source 14 is further connected to a second input end of the control unit 12 and is configured to provide the input voltage to the control unit 12.

In addition, in this embodiment, the control unit 12 is disposed separately from the power adjusting unit 14, but in a practical application, the power adjusting unit 14 may be integrated into the control unit 12. In this case, an output end may be set additionally in the control unit 12, and a function of the output end is the same as that of an output end 133 of the power adjusting unit 13.

When a supply voltage of a power supply system changes, the electronic heater provided in the present disclosure can intelligently adjust a current of a heating source of the electronic heater to maintain output power of the heating source unchanged, and therefore, an operator can make a cabinet maintain the same working temperature without changing different electronic heaters; and in addition, when the supply voltage of the power supply system maintains unchanged but capacity of the cabinet changes, the electronic heater provided in the present disclosure can adjust the current of the heating source of the electronic heater to increase or decrease output power of the heating source to maintain a proper working temperature of a cabinet of different capacity, and therefore, the operator does not need to equip an electronic heater of different power for a cabinet of different capacity. Therefore, by using the electronic heater provided in this embodiment of the present disclosure, a warehousing cost and a maintenance cost of a spare part of the electronic heater are reduced.

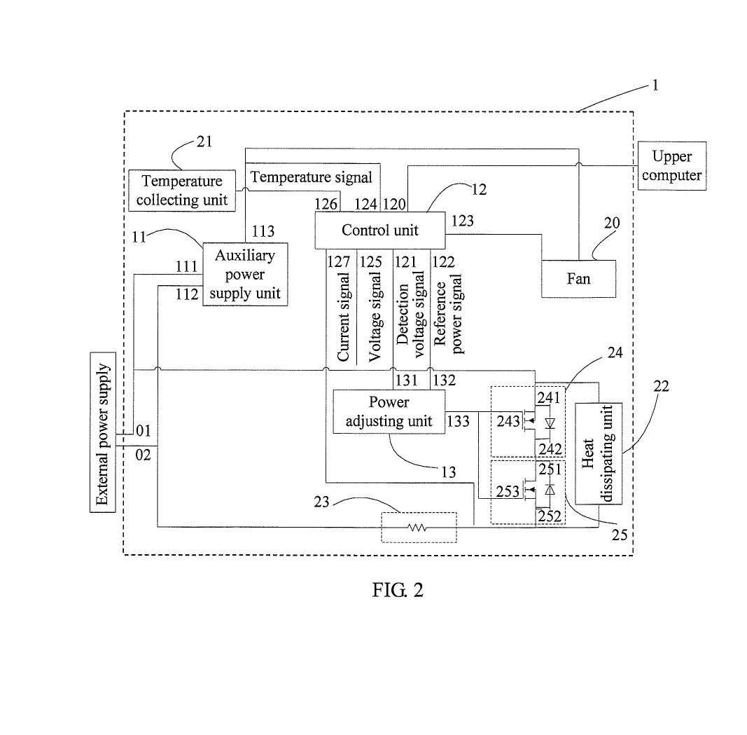

As shown in FIG. 2, a second embodiment of the present disclosure provides an electronic heater 1, which, as shown by a dashed line box in FIG. 2, includes an auxiliary power supply unit 11, a control unit 12, a power adjusting unit 13, and a heating source. In addition, the electronic heater further includes a fan 20, a temperature collecting unit 21, a heat dissipating unit 22, and a sampling resistor 23. The heating source specifically includes a first power device 24 and a second power device 25. In a process of manufacturing the electronic heater, the auxiliary power supply unit 11, the control unit 12, the power adjusting unit 13, the first power device 24, the second power device 25, the heat dissipating unit 22, and the sampling resistor 23 may be integrated onto a control board of the electronic heater. Due to a restriction on the height of the electronic heater, neither the fan 20 nor the temperature collecting unit 21 is integrated onto the control board. However, if there is no restriction on the height of the electronic heater, the fan 20 and the temperature collecting unit 21 may also be installed on the control board.

The power adjusting unit 13 may be an operation amplifier, or a triode, or a combination of an operation amplifier and a triode; the temperature collecting unit 21 may be a temperature sensor; the heat dissipating unit 22 may be a heat sink device; and the first power device 24 and the second power device 25 may be active power devices such as MOSFET (Metal-Oxide-Semiconductor Field-Effect Transistor, metal-oxide-semiconductor field-effect transistor), triode, or IGBT (Insulated Gate Bipolar Transistor, insulated gate bipolar transistor) and are configured to convert electric energy into heat energy. In this embodiment, a first MOSFET is used as the first power device 24, and a second MOSFET is used as the second power device 25.

In this case, a source electrode 241 of the first MOSFET 24 is connected to a first electrode 01 of the external power supply, a drain electrode 242 of the first MOSFET 24 is connected to a drain electrode 251 of the second MOSFET 25, a source electrode 252 of the second MOSFET 25 is connected to a second electrode 02 of the external power supply, and an output end 133 of the power adjusting unit 13 is connected to both a gate electrode 243 of the first MOSFET 24 and a gate electrode 253 of the second MOSFET 25.

In addition, a first input end 111 and a second input end 112 of the auxiliary power supply unit 11 are connected to the first electrode 01 and the second electrode 02 of the external power supply respectively; and the output end 113 of the auxiliary power supply unit 11 is connected to both the fan 20 and a first input end 124 of the control unit 12. A first output end 121 and a second output end 122 of the control unit 12 are connected to a first input end 131 and a second input end 132 of the power adjusting unit 13 respectively. The source electrode 241 of the first MOSFET 24 is connected to a second input end 125 of the control unit 12. The temperature collecting unit 21 is connected to a third input end 126 of the control unit 12 and a third output end 123 of the control unit is connected to the fan 20. A first end 231 of the sampling resistor 23 is connected to the source electrode of the second MOSFET 25 and a second end 232 of the sampling resistor 23 is connected to the second electrode 02 of the external power supply. The source electrode 252 of the second MOSFET 25 is connected to a fourth input end 127 of the control unit 12. The heat dissipating unit 22 is connected to the first MOSFET 24 and the second MOSFET 25 and is configured to dissipate heat of the first MOSFET 24 and the second MOSFET 25. In addition, an output/input port 120 of the control unit 12 is connected to an upper computer outside the electronic heater.

When the external power supply supplies power, after transforming a voltage of the external power supply, the auxiliary power supply unit 11 sends the voltage to the fan 20 and the control unit 12 respectively to supply power to the fan 20 and the control unit 12. The control unit 12 outputs a detection voltage signal according to a voltage signal obtained by the source electrode 241 of the first MOSFET 24, outputs a power control signal according to a reference power value obtained by the upper computer, and sends the detection voltage signal and the power control signal to the power adjusting unit 13. The power adjusting unit 13 obtains an output power adjustment signal according to the detection voltage signal and the power control signal, and adjusts a current of the first MOSFET 24 and a current of the second MOSFET 25 by using the output power adjustment signal, so as to adjust output power of the first MOSFET 24 and output power of the second MOSFET 25. The first MOSFET 24 and the second MOSFET 25 are supplied with power by the external power supply.

Specifically, when the voltage of the external power supply is a direct current voltage, the auxiliary power supply unit 11 transforms the direct current voltage into a voltage form suitable for the fan 20 and the control unit 12; and when the voltage of the external power supply is an alternating current voltage, the auxiliary power supply unit 11 first rectifies the alternating current voltage to a direct current voltage and then transforms the direct current voltage into a voltage form suitable for the fan 20 and the control unit 12.

In a working process of the electronic heater, when the external power supply is an alternating current power supply, the first MOSFET 24 may be reversely connected with the second MOSFET 25 in series to prevent the first MOSFET 24 or the second MOSFET 25 from being uncontrollable when the electronic heater includes only the first MOSFET 24 or the second MOSFET 25 and a parasitic diode inside the first MOSFET 24 or the second MOSFET 25 is turned on in a reverse voltage stage. In addition, to increase output power of the electronic heater, the heating source may also include multiple parallel-connected first power devices 24 and multiple parallel-connected second power devices 25, and the multiple parallel-connected first power devices 24 are connected with the multiple parallel-connected second power devices 25 in series.

The output/input port 120 of the control unit 12 has a 485 communication function, and may communicate with the upper computer. Specifically, the control unit 12 may report a fault alarm to the upper computer, and the upper computer obtains a reference power value required by a user.

In addition, the temperature collecting unit 21 inputs a temperature signal to the third input end 126 of the control unit 12, so that the control unit 12 controls a rotation speed of the fan 20 by using the temperature signal, to ensure that a temperature of the electronic heater is within a safe range and an operator is not burned. Specifically, as the rotation speed of the fan decreases, noise of the fan also decreases, and the heat dissipation capability of the fan also decreases accordingly; and as the rotation speed of the fan increases, the noise of the fan also increases, and the heat dissipation capability of the fan also increases accordingly.

In this embodiment, the heat dissipating unit 22 is connected to the first MOSFET 24 and the second MOSFET 25, but in a practical application, if a rectifying unit further exists in the electronic heater (as described in the following embodiments), the heat sink device 22 may be further connected to the rectifying unit and is configured to dissipate heat of the rectifying unit, so as to improve heat utilization. Generally, the heater is configured to expand a point heat source to a plane heat source, that is, expand a heat dissipation area evenly to facilitate air blowing from the fan; and meanwhile, the heat sink device can further reduce thermal resistance, to ensure that an internal junction temperature of a power device that is connected to the heat sink device is within a safe working temperature range. The material of the heat sink device is metal, and preferably, is metal with good heat conduction performance, such as aluminum or copper.

In a circuit in which the sampling resistor 23 is added, the control unit 12 detects, by using a current signal obtained by the source electrode 252 of the second MOSFET 25, whether overcurrent of the heating source occurs, so as to protect the electronic heater. Specifically, when the control unit 12 detects, according to the current signal, that overcurrent of the first MOSFET 24 and the second MOSFET 25 occurs, the control unit 12 cuts off the circuit immediately, so as to protect the electronic heater.

In addition, in this embodiment, the control unit 12 is disposed separately from the power adjusting unit 13, but in a practical application, the power adjusting unit 13 may be integrated into the control unit 12. In this case, an output end may be set additionally in the control unit 12, and a function of the output end is the same as that of the output end 133 of the power adjusting unit 13.

When a supply voltage of a power supply system changes, the electronic heater provided in the present disclosure can intelligently adjust a current of a first MOSFET and a current of a second MOSFET to maintain output power of the heating source unchanged, and therefore, an operator can make a cabinet maintain the same working temperature without changing different electronic heaters; and in addition, when the supply voltage of the power supply system maintains unchanged but capacity of the cabinet changes, the electronic heater provided in the present disclosure can adjust the current of the first MOSFET and the current of the second MOSFET to increase or decrease output power of the heating source to maintain a proper working temperature of a cabinet of different capacity, and therefore, the operator does not need to equip an electronic heater of a different power for a cabinet of different capacity. Therefore, by using the electronic heater provided in this embodiment of the present disclosure, a warehousing cost and a maintenance cost of a spare part of the electronic heater are reduced.

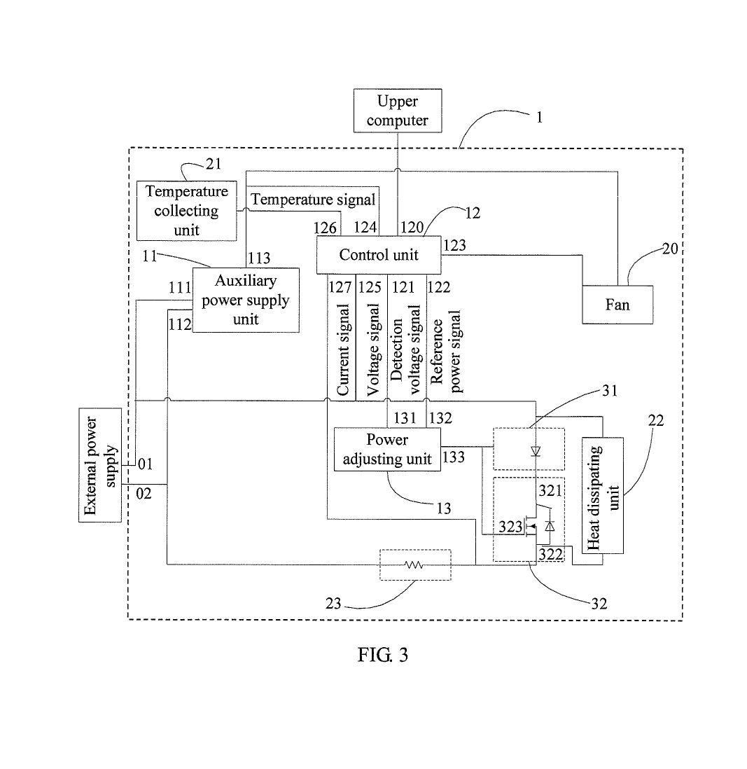

As shown in FIG. 3, a third embodiment of the present disclosure provides an electronic heater. A difference from FIG. 2 lies in that the heating source specifically includes a diode 31 and a power device 32.

The power device 32 may be an active power device such as MOSFET, triode, or IGBT. In this embodiment, a MOSFET is used as the power device 32. In this case, an anode of the diode 31 is connected to a first electrode 01 of the external power supply, a cathode of the diode 31 is connected to a drain electrode 321 of the MOSFET 32, a source electrode 322 of the MOSFET 32 is connected to a second electrode 02 of the external power supply, and a gate electrode 323 of the MOSFET 32 is connected to an output end 133 of the power adjusting unit 13.

In a working process of the electronic heater, when the external power supply is an alternating current power supply and the alternating current power supply outputs negative electric energy, due to a unidirectional conduction principle of the diode, the electronic heater cannot work, that is, the electronic heater cannot supply power to a cabinet in which the electronic heater is located.

In addition, for working principles of an auxiliary power supply unit 11, a fan 20, a control unit 12, a power adjusting unit 13, a temperature collecting unit 21, a heat dissipating unit 22, and a sampling resistor 23 shown in FIG. 3, reference may be made to the second embodiment of the present disclosure.

When a supply voltage of a power supply system changes, the electronic heater provided in the present disclosure can intelligently adjust a current of a MOSFET to maintain output power of the heating source unchanged, and therefore, an operator can make a cabinet maintain the same working temperature without changing different electronic heaters; and in addition, when the supply voltage of the power supply system maintains unchanged but capacity of the cabinet changes, the electronic heater provided in the present disclosure can adjust the current of the MOSFET to increase or decrease output power of the heating source to maintain a proper working temperature of a cabinet of different capacity, and therefore, the operator does not need to equip an electronic heater of different power for a cabinet of different capacity. Therefore, by using the electronic heater provided in this embodiment of the present disclosure, a warehousing cost and a maintenance cost of a spare part of the electronic heater are reduced.

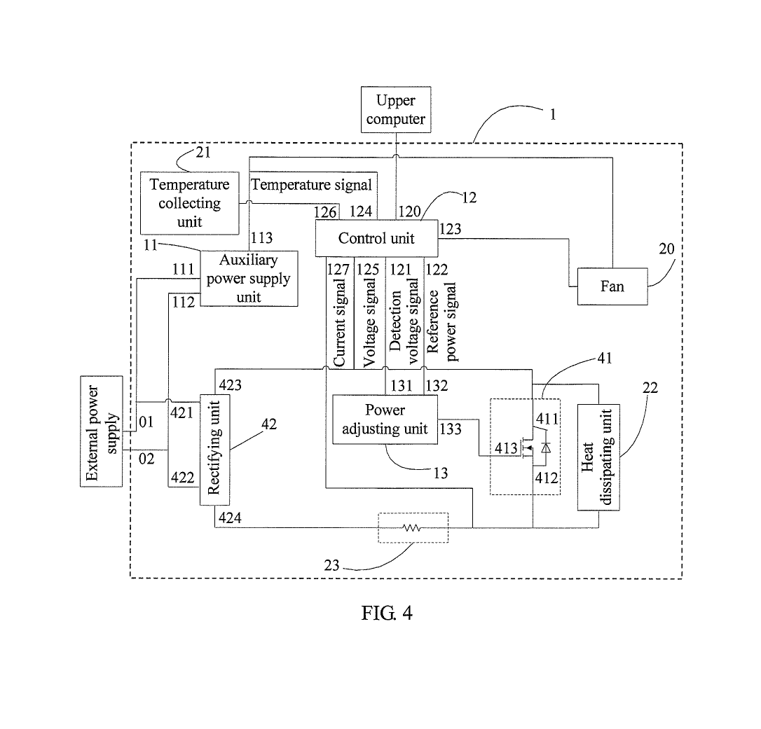

As shown in FIG. 4, a fourth embodiment of the present disclosure provides an electronic heater. A difference from FIG. 2 lies in that the heating source specifically includes a power device 41 and the electronic heater further includes a rectifying unit 42.

The power device 41 may be an active power device such as MOSFET, triode, or IGBT. In this embodiment, a MOSFET is used as the power device 41. In this case, a first input end 421 and a second input end 422 of the rectifying unit are connected to a first electrode 01 and a second electrode 02 of the external power supply respectively and are configured to receive electric energy supply of the external power supply; a first output end 423 and a second output end 424 of the rectifying unit are connected to a drain electrode 411 and a source electrode 412 of the MOSFET 41 respectively and are configured to supply power to the power device; and a gate electrode 413 of the power device 41 is connected to an output end 133 of the power adjusting unit 13 and is configured to adjust a current output of the power device 41 according to a power control signal output by the power adjusting unit.

When the external power supply supplies power, after transforming a voltage of the external power supply, the auxiliary power supply unit 11 sends the voltage to the fan 20 and the control unit 12 respectively to supply power to the fan 20 and the control unit 12. After rectifying the voltage of the external power supply, the rectifying unit 42 sends the voltage to the MOSFET 41 to supply power to the MOSFET 41. The control unit 12 outputs a detection voltage signal according to a voltage signal obtained by the drain electrode 411 of the MOSFET 41, outputs a power control signal according to a reference power value obtained by the upper computer, and sends the detection voltage signal and the power control signal to the power adjusting unit 13. The power adjusting unit 13 obtains an output power adjustment signal according to the detection voltage signal and the power control signal, and adjusts a current of the MOSFET 41 by using the output power adjustment signal, so as to adjust output power of the MOSFET 41.

In this embodiment, the rectifying unit 42 may be an uncontrollable silicon rectifier stack. The rectifier stack may include four separate power devices such as power diodes. In a working process of the electronic heater, specific functions of the rectifying unit 42 are as follows:

First, when the voltage of the external power supply is an alternating current voltage, the rectifying unit 42 may rectify the alternating current voltage to a direct current voltage and provide the direct current voltage for the power device 41. In this case, by using the rectifying unit, the electronic heater not only can make full use of alternating current energy but also can provide a steady direct current voltage for the heating source.

Second, when the voltage of the external power supply is a direct current voltage, the power device 41 is prevented from being uncontrollable when a parasitic diode inside the power device 41 is turned on at the time when a voltage direction is reverse.

When a supply voltage of a power supply system changes, the electronic heater provided in the present disclosure can intelligently adjust a current of a MOSFET to maintain output power of the heating source unchanged, and therefore, an operator can make a cabinet maintain the same working temperature without changing different electronic heaters; and in addition, when the supply voltage of the power supply system maintains unchanged but capacity of the cabinet changes, the electronic heater provided in the present disclosure can adjust the current of the MOSFET to increase or decrease output power of the heating source to maintain a proper working temperature of a cabinet of different capacity, and therefore, the operator does not need to equip an electronic heater of different power for a cabinet of different capacity. Therefore, by using the electronic heater provided in this embodiment of the present disclosure, a warehousing cost and a maintenance cost of a spare part of the electronic heater are reduced.

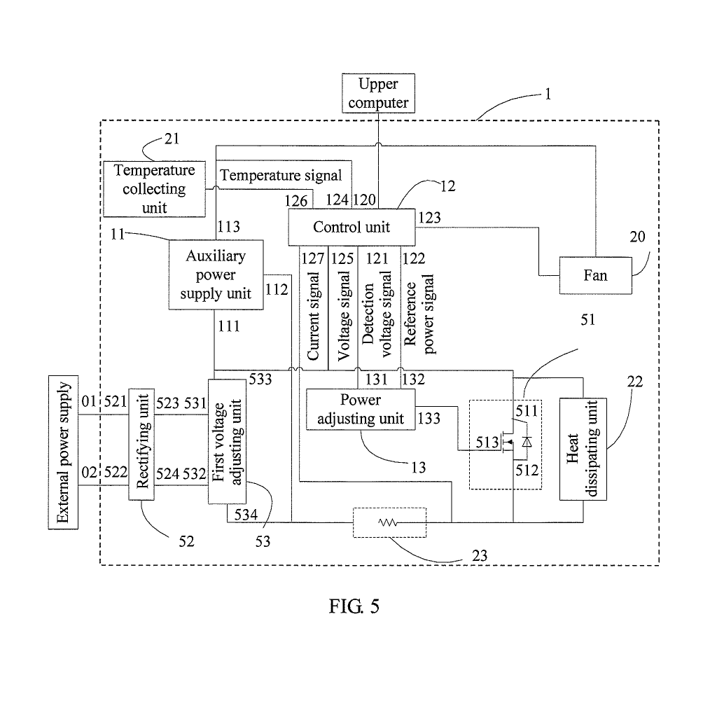

As shown in FIG. 5, a fifth embodiment of the present disclosure provides an electronic heater. A difference from FIG. 2 lies in that the heating source specifically includes a power device 51, the electronic heater further includes a rectifying unit 52 and a first voltage adjusting unit 53, and the auxiliary unit 11 is not directly connected to the external power supply, but is connected to the first voltage adjusting unit 53.

The power device 51 may be an active power device such as MOSFET, triode, or IGBT, and the first voltage adjusting unit 53 may be a large-capacity capacitor. In this embodiment, a MOSFET is used as the power device 51. In this case, a first input end 521 and a second input end 522 of the rectifying unit 52 are connected to a first electrode 01 and a second electrode 02 of the external power supply respectively and are configured to receive electric energy supply of the external power supply; a first output end 523 and a second output end 524 of the rectifying unit 52 are connected to a first input end 531 and a second input end 532 of the first voltage adjusting unit 53 respectively and are configured to provide rectified electric energy for the first voltage adjusting unit; a first output end 533 and a second output end 534 of the first voltage adjusting unit 53 are connected to a first input end 111 and a second input end 112 of the auxiliary power supply unit 11 and to a drain electrode 511 and a source electrode 512 of the MOSFET 51 respectively, and are configured to provide adjusted electric energy for the auxiliary power supply unit and the power device respectively; and a gate electrode 513 of the MOSFET 51 is connected to an output end 133 of the power adjusting unit 13 and is configured to adjust a current output of the MOSFET 51 according to a power control signal output by the power adjusting unit.

When the external power supply supplies power, after rectifying a voltage of the external power supply, the rectifying unit 52 sends the voltage to the first voltage adjusting unit 53; and after adjusting the voltage from the rectifying unit 52, the first voltage adjusting unit 53 sends the voltage to the auxiliary power supply unit 11 and the MOSFET 51 to supply power to the auxiliary power supply unit 11 and the MOSFET 51. After transforming the voltage from the first voltage adjusting unit 53, the auxiliary power supply unit 11 sends the voltage to the fan 20 and the control unit 12 respectively to supply power to the fan 20 and the control unit 12. The control unit 12 outputs a detection voltage signal according to a voltage signal obtained by the drain electrode 511 of the MOSFET 51, outputs a power control signal according to a reference power value obtained by the upper computer, and sends the detection voltage signal and the power control signal to the power adjusting unit 13. The power adjusting unit 13 obtains an output power adjustment signal according to the detection voltage signal and the power control signal, and adjusts a current of the MOSFET 51 by using the output power adjustment signal, so as to adjust output power of the MOSFET 51.

Specifically, when the external power supply is an alternating current power supply, the electronic heater can rectify alternating current energy to direct current energy by using the rectifying unit 52, and can further perform shaping such as filtering and voltage stabilizing on a rectified voltage by using the first voltage adjusting unit 53, so as to provide a steadier voltage for the power device and the auxiliary power supply unit. For a working principle of the rectifying unit 52, reference may be made to the description in the fourth embodiment of the present disclosure.

Further, in this embodiment, an input end of the auxiliary power supply unit 11 is connected to an output end of the first voltage adjusting unit 53, while in the fourth embodiment, the input end of the auxiliary power supply unit 11 is directly connected to the external power supply. In this embodiment, electric energy output by the first voltage adjusting unit 53 is steadier than electric energy output by the external power supply, and therefore, in this embodiment, electric energy provided for the auxiliary power supply unit 11 is steadier.

When a supply voltage of a power supply system changes, the electronic heater provided in the present disclosure can intelligently adjust a current of a MOSFET to maintain output power of the heating source unchanged, and therefore, an operator can make a cabinet maintain the same working temperature without changing different electronic heaters; and in addition, when the supply voltage of the power supply system maintains unchanged but capacity of the cabinet changes, the electronic heater provided in the present disclosure can adjust the current of the MOSFET to increase or decrease output power of the heating source to maintain a proper working temperature of a cabinet of different capacity, and therefore, the operator does not need to equip an electronic heater of different power for a cabinet of different capacity. Therefore, by using the electronic heater provided in this embodiment of the present disclosure, a warehousing cost and a maintenance cost of a spare part of the electronic heater are reduced.

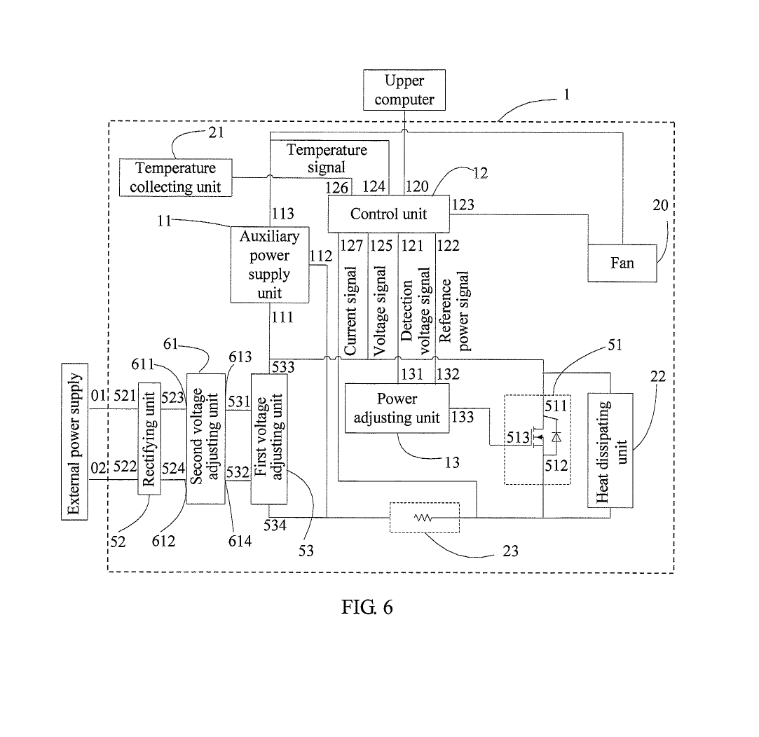

As shown in FIG. 6, a sixth embodiment of the present disclosure provides an electronic heater, which, based on FIG. 5, further includes a second voltage adjusting unit 61.

A first input end 611 and a second input end 612 of the second voltage adjusting unit 61 are connected to the first output end 523 and the second output end 524 of the rectifying unit 52 respectively and are configured to receive electric energy supply of the rectifying unit; and a first output end 613 and a second output end 614 of the second voltage adjusting unit are connected to the first input end 531 and the second input end 532 of the first voltage adjusting unit respectively and are configured to provide adjusted electric energy for the first voltage adjusting unit. That is, the second voltage adjusting unit is located between the rectifying unit and the first voltage adjusting unit, and the three are connected in parallel.

When the external power supply supplies power, after rectifying a voltage of the external power supply, the rectifying unit 52 sends the voltage to the second voltage adjusting unit 61; and after adjusting the voltage from the rectifying unit 52, the second voltage adjusting unit 61 sends the voltage to the first voltage adjusting unit 53, so that the first voltage adjusting unit adjusts the voltage and sends the adjusted voltage to the auxiliary power supply unit 11 and the MOSFET 51 to supply power to the auxiliary power supply unit 11 and the MOSFET 51. After transforming the voltage from the first voltage adjusting unit, the auxiliary power supply unit 11 sends the voltage to the fan 20 and the control unit 12 respectively to supply power to the fan 20 and the control unit 12. The control unit 12 outputs a detection voltage signal according to a voltage signal obtained by the drain electrode 511 of the MOSFET 51, outputs a power control signal according to a reference power value obtained by the upper computer, and sends the detection voltage signal and the power control signal to the power adjusting unit 13. The power adjusting unit 13 obtains an output power adjustment signal according to the detection voltage signal and the power control signal, and adjusts a current of the MOSFET 51 by using the output power adjustment signal, so as to adjust output power of the MOSFET 51.

The second power adjusting unit may be a PFC (Power Factor Correction, power factor correction) circuit or a boost circuit. The PFC circuit is specifically configured to eliminate a harmonic wave of a large-power rectifying circuit and improve quality of electric energy; or, when an input current is a direct current, the boost circuit can boost a voltage, so that the current is steadier.

When a supply voltage of a power supply system changes, the electronic heater provided in the present disclosure can intelligently adjust a current of a MOSFET to maintain output power of the heating source unchanged, and therefore, an operator can make a cabinet maintain the same working temperature without changing different electronic heaters; and in addition, when the supply voltage of the power supply system maintains unchanged but capacity of the cabinet changes, the electronic heater provided in the present disclosure can adjust the current of the MOSFET to increase or decrease output power of the heating source to maintain a proper working temperature of a cabinet of different capacity, and therefore, the operator does not need to equip an electronic heater of different power for a cabinet of different capacity. Therefore, by using the electronic heater provided in this embodiment of the present disclosure, a warehousing cost and a maintenance cost of a spare part of the electronic heater are reduced.

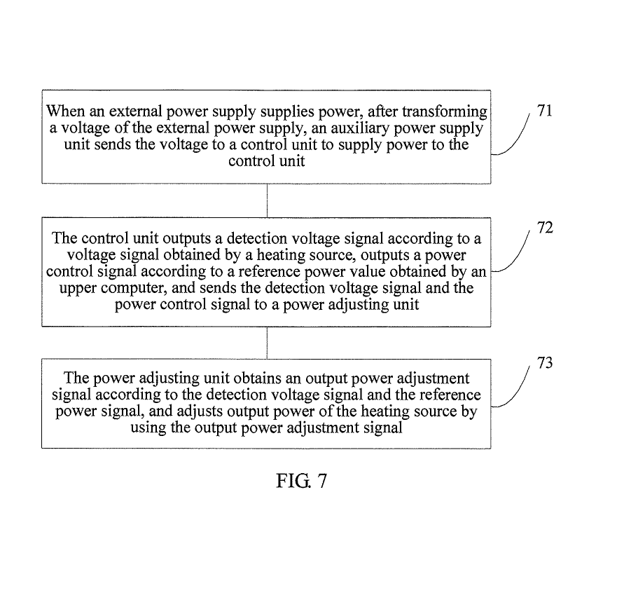

As shown in FIG. 7, a seventh embodiment of the present disclosure provides a method for controlling an electronic heater. The electronic heater includes an auxiliary power supply unit, a control unit, a power adjusting unit, and a heating source. The method includes:

Step 71: When an external power supply supplies power, after transforming a voltage of the external power supply, the auxiliary power supply unit sends the voltage to the control unit to supply power to the control unit.

Step 72: The control unit outputs a detection voltage signal according to a voltage signal obtained by the heating source, outputs a power control signal according to a reference power value obtained by the upper computer, and sends the detection voltage signal and the power control signal to the power adjusting unit.

Step 73: The power adjusting unit obtains an output power adjustment signal according to the detection voltage signal and the power control signal, and adjusts output power of the heating source by using the output power adjustment signal.

In this embodiment, if a structure of the electronic heater is different, a working principle of the electronic heater changes accordingly, which is specifically as follows:

When the heating source includes a power device and the electronic heater further includes a rectifying unit, after rectifying the voltage of the external power supply, the rectifying unit transmits the voltage to the power device to supply power to the power device.

When the heating source includes a power device and the electronic heater further includes a rectifying unit and a first voltage adjusting unit, after rectifying the voltage of the external power supply, the rectifying unit sends the voltage to the first voltage adjusting unit; and after adjusting the voltage from the rectifying unit, the first voltage adjusting unit sends the voltage to the auxiliary power supply unit and the power device to supply power to the auxiliary power supply unit and the power device.

When the heating source includes a power device and the electronic heater further includes a rectifying unit, a first voltage adjusting unit, and a second voltage adjusting unit, after rectifying the voltage of the external power supply, the rectifying unit sends the voltage to the second voltage adjusting unit; and after adjusting the voltage from the rectifying unit, the second voltage adjusting unit sends the voltage to the first voltage adjusting unit, so that the first voltage adjusting unit adjusts the voltage and sends the adjusted voltage to the auxiliary power supply unit and the power device to supply power to the auxiliary power supply unit and the power device.

In addition, when the electronic heater further includes a temperature collecting unit and a fan, the temperature collecting unit inputs a temperature signal to the control unit, so that the control unit controls a rotation speed of the fan by using the temperature signal.

When the electronic heater further includes a heat dissipating unit, the heat dissipating unit dissipates heat of the heating source or the rectifying unit.

When the electronic heater further includes a sampling resistor, in a circuit in which the sampling resistor is added, the control unit detects, by using a current signal obtained by the sampling resistor from the heating source and according to the current signal, whether overcurrent of the heating source occurs.

For the method for controlling an electronic heater, reference may be made to the foregoing descriptions of the first to sixth embodiments.

Further, in this embodiment, the control unit is disposed separately from the power adjusting unit, but in a practical application, the power adjusting unit may be integrated into the control unit.

When a supply voltage of a power supply system changes, the electronic heater provided in the present disclosure can intelligently adjust a current of a heating source of the electronic heater to maintain output power of the heating source unchanged, and therefore, an operator can make a cabinet maintain the same working temperature without changing different electronic heaters; and in addition, when the supply voltage of the power supply system maintains unchanged but capacity of the cabinet changes, the electronic heater provided in the present disclosure can adjust the current of the heating source of the electronic heater to increase or decrease output power of the heating source to maintain a proper working temperature of a cabinet of different capacity, and therefore, the operator does not need to equip an electronic heater of different power for a cabinet of different capacity. Therefore, by using the technical solutions in the embodiments of the present disclosure, a warehousing cost and a maintenance cost of a spare part of the electronic heater are reduced.

The foregoing descriptions are only specific implementation manners of the present disclosure, but are not intended to limit the protection scope of the present disclosure. Any variation or replacement readily figured out by persons skilled in the art within the technical scope disclosed in the present disclosure shall all fall within the protection scope of the present disclosure. Therefore, the protection scope of the present disclosure shall be subject to the protection scope of the claims.

What is claimed is:

1. An electronic heater, comprising an auxiliary power supply unit, a control unit, a power adjusting unit, and a heating source, wherein:
the auxiliary power supply unit is configured to supply power to the control unit;
the control unit is configured to output a detection voltage signal according to an input voltage of the heating source, output a power control signal according to a preset reference power value, and transmit the detection voltage signal and the power control signal to the power adjusting unit; and
the power adjusting unit is configured to obtain an output power adjustment signal according to the detection voltage signal and the power control signal, and adjust an input current of the heating source according to the power adjustment signal.

2. The electronic heater according to claim 1, wherein:
an input end of the auxiliary power supply unit is connected to an external power supply and is configured to receive electric energy supply of the external power supply; and an output end of the auxiliary power supply unit is connected to a first input end of the control unit and is configured to supply power to the control unit;
a first output end and a second output end of the control unit are connected to a first input end and a second input end of the power adjusting unit respectively and are configured to transmit the detection voltage signal and the power control signal to the power adjusting unit;
an output end of the power adjusting unit is connected to a control end of the heating source and is configured to adjust the input current of the heating source according to the power adjustment signal; and
a first input end and a second input end of the heating source are connected to a first electrode and a second electrode of the external power supply respectively and are configured to receive the electric energy supply of the external power supply, and the first input end of the heating source is further connected to a second input end of the control unit and is configured to provide the input voltage for the control unit.

3. The electronic heater according to claim 1, wherein:
the heating source comprises a first power device and a second power device; and
a first end of the first power device is connected to a first electrode of an external power supply, a second end of the first power device is connected to a second end of the second power device, a first end of the second power device is connected to a second electrode of the external power supply, and a control end of the first power device and a control end of the second power device are both connected to an output end of the power adjusting unit; or
the heating source comprises a diode and a power device; and
an anode of the diode is connected to a first electrode of the external power supply, a cathode of the diode is connected to a first end of the power device, a second end of the power device is connected to a second electrode of the external power supply, and a control end of the power device is connected to an output end of the power adjusting unit.

4. The electronic heater according to claim 1, wherein:
the heating source comprises a power device, and the electronic heater further comprises a rectifying unit;
a first input end and a second input end of the rectifying unit are connected to a first electrode and a second electrode of an external power supply respectively and are configured to receive electric energy supply of the external power supply, a first output end and a second output end of the rectifying unit are connected to a first end and a second end of the power device respectively and are configured to supply power to the power device, and a control end of the power device is connected to an output end of the power adjusting unit and is configured to adjust a current output of the power device according to the power control signal output by the power adjusting unit; and
after rectifying a voltage of the external power supply, the rectifying unit sends the voltage to the power device to supply power to the power device.

5. The electronic heater according to claim 1, wherein:
the electronic heater further comprises a rectifying unit and a first voltage adjusting unit, and the heating source comprises a power device;
a first input end and a second input end of the rectifying unit are connected to a first electrode and a second electrode of an external power supply respectively and are configured to receive electric power supply of the external power supply, a first output end and a second output end of the rectifying unit are connected to a first input end and a second input end of the first voltage adjusting unit respectively and are configured to provide rectified electric energy for the first voltage adjusting unit, a first output end and a second output end of the first voltage adjusting unit are connected to a first input end and a second input end of the auxiliary power supply unit and to a first end and a second end of the power device respectively, and are configured to provide adjusted electric energy for the auxiliary power supply unit and the power device respectively, and a control end of the power device is connected to an output end of the power adjusting unit and is configured to adjust a current output of the power device according to the power control signal output by the power adjusting unit; and
after rectifying a voltage of the external power supply, the rectifying unit sends the voltage to the first voltage adjusting unit, and after adjusting the voltage from the rectifying unit, the first voltage adjusting unit sends the voltage to the auxiliary power supply unit and the power device to supply power to the auxiliary power supply unit and the power device.

6. The electronic heater according to claim 5, further comprising a second voltage adjusting unit, wherein:
a first input end and a second input end of the second voltage adjusting unit are connected to the first output end and the second output end of the rectifying unit respectively and are configured to receive electric energy supply of the rectifying unit, and a first output end and a second output end of the second voltage adjusting unit are connected to the first input end and the second input end of the first voltage adjusting unit respectively and are configured to provide adjusted electric energy for the first voltage adjusting unit; and
after adjusting the voltage from the rectifying unit, the second voltage adjusting unit sends the voltage to the first voltage adjusting unit, so that the first voltage adjusting unit adjusts the voltage from the second voltage adjusting unit.

7. The electronic heater according to claim 1, further comprising a temperature collecting unit and a fan, wherein:
the temperature collecting unit is connected to a third input end of the control unit and a third output end of the control unit is connected to the fan; and
the temperature collecting unit inputs a temperature signal to the control unit, so that the control unit controls a rotation speed of the fan by using the temperature signal.

8. The electronic heater according to claim 1, further comprising a heat dissipating unit, wherein:
the heat dissipating unit is connected to the heating source and is configured to dissipate heat of the heating source.

9. The electronic heater according to claim 1, further comprising a sampling resistor, wherein:
a first end of the sampling resistor is connected to the second input end of the heating source and a second end of the sampling resistor is connected to the second electrode of the external power supply; and the second input end of the heating source is connected to a fourth input end of the control unit; and
the control unit detects, by using a current signal obtained by the second input end of the heating source, whether overcurrent of the heating source occurs.

10. A method for controlling an electronic heater comprising an auxiliary power supply unit, a control unit, a power adjusting unit, and a heating source, the method comprising:
when an external power supply supplies power, after transforming a voltage of the external power supply, sending, by the auxiliary power supply unit, the voltage to the control unit to supply power to the control unit;
outputting, by the control unit, a detection voltage signal according to a voltage signal obtained by the heating source, outputting a power control signal according to a preset reference power value, and sending the detection voltage signal and the power control signal to the power adjusting unit; and
obtaining, by the power adjusting unit, an output power adjustment signal according to the detection voltage signal and the power control signal, and adjusting a current of the heating source by using the output power adjustment signal, so as to adjust output power of the heating source.

11. The method according to claim 10, wherein:
when the heating source comprises a power device and the electronic heater further comprises a rectifying unit, and when the external power supply supplies power, the method further comprises:
after rectifying the voltage of the external power supply, sending, by the rectifying unit, the voltage to the power device to supply power to the power device.

12. The method according to claim 10, wherein:
when the heating source comprises a power device and the electronic heater further comprises a rectifying unit and a first voltage adjusting unit, sending, by the auxiliary power supply unit, the voltage to the control unit comprises:
after rectifying the voltage of the external power supply, sending, by the rectifying unit, the voltage to the first voltage adjusting unit; and after adjusting the voltage from the rectifying unit, sending, by the first voltage adjusting unit, the voltage to the auxiliary power supply unit, so that after transforming the voltage of the first voltage adjusting unit, the auxiliary power supply unit sends the voltage to the control unit; and
when the external power supply supplies power, the method further comprises:
after rectifying the voltage of the external power supply, sending, by the rectifying unit, the voltage to the first voltage adjusting unit, and after adjusting the voltage from the rectifying unit, sending, by the first voltage adjusting unit, the voltage to the power device to supply power to the power device.

13. The method according to claim 12, wherein:
when the electronic heater further comprises a second voltage adjusting unit, sending, by the rectifying unit, the voltage to the first voltage adjusting unit comprises:
after rectifying the voltage of the external power supply, sending, by the rectifying unit, the voltage to the second voltage adjusting unit; and after adjusting the voltage from the rectifying unit, sending, by the second voltage adjusting unit, the voltage to the first voltage adjusting unit, so that the first voltage adjusting unit adjusts the voltage from the second voltage adjusting unit.

14. The method according to claim 10, wherein:
when the electronic heater further comprises a temperature collecting unit and a fan, the temperature collecting unit inputs a temperature signal to the control unit, so that the control unit controls a rotation speed of the fan by using the temperature signal.

15. The method according to claim 10, wherein:
when the electronic heater further comprises a heat dissipating unit, the heat dissipating unit dissipates heat of the heating source.

16. The method according to claim 10, wherein:
when the electronic heater further comprises a sampling resistor, the control unit detects, by using a current signal obtained by the sampling resistor from a second input end of the heating source and according to the current signal, whether overcurrent of the heating source occurs.
